(19) United States
(12) Patent Application Publication
(10) Pub. No.: US 2009/0031861 A1
(43) Pub. Date: Feb. 5, 2009

(54) Apparatus And Process For Recovery Of Values From A Value Bearing Material

(75) Inventor: Roger H. Wintle, Florida (ZA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Futuremet (PTY) Ltd., Craighall Park (ZA)

(21) Appl. No.: 11/662,772

(22) PCT Filed: Sep. 13, 2005
(86) PCT No.: PCT/IB2005/002707

§ 371 Date: Oct. 25, 2007

(30) Foreign Application Priority Data
Sep. 13, 2004 (ZA) 2004/7323

(51) Int. Cl. C22B 3/00; C22B 3/02

(52) U.S. Cl. 75/710; 266/168

(57) ABSTRACT

A process and apparatus for continuously stripping or recovering values from a value bearing material, typically a slurry or solution thereof. The resin and value bearing material are contacted in a counter-current manner in a contact zone to load the resin with values from the value bearing material. The resin is fluidised by the value bearing material in the contact zone. The loaded resin is passed through a first washing zone to displace excess value bearing material. The loaded resin then passes through a stripping zone, typically an acid or alkali, to strip the values from the resin and form an eluate, which is treated further to recover the values. The stripped resin is washed in a second washing zone, to displace excess stripping agent, and returned to the contact zone.

### BACKGROUND OF THE INVENTION

THIS invention relates to an apparatus and process for stripping or recovering values from a value bearing material, such as metal values from a metal value bearing material.

In the conventional hydrometallurgical treatment and refining of base metals, typical processes comprise a leaching stage using sulphuric acid followed by an iron removal stage for removing the iron, typically as a finely divided hydroxide precipitate. The residues emanating from these processes are usually filtered and discarded with an associated “metal value” entrained loss.

Attempts have been made to recover these “metal value” losses. These include washing and/or repulping, which are typically not quantitative and normally dilute the main processing stream. Thus, an economic trade-off is normally reached between additional capital and operating costs and improved recovery.

The metal losses from leach and purification residues from a conventional hydrometallurgical process are significant and are typically in the order of 1 to 5% of total throughput. More often than not the metal values in these residues also constitute an environmental problem.

Although so-called resin-in-pulp technology is thought to hold potential for the recovery of lost metal and other value materials, and reduce the environmental impact, the lack of simple processing equipment presents a major problem with the application of this technology.

### SUMMARY OF THE INVENTION

According to the present invention, a continuous process for stripping or recovering values from a value bearing material includes the steps of:
(i) providing a resin and a source of value bearing material, typically a slurry or solution containing the value bearing material;
(ii) contacting the resin and value bearing material in a counter-current manner in a contact zone to load the resin with values from the value bearing material, the resin being fluidised by the value bearing material in the contact zone;
(iii) optionally passing the loaded resin through a first washing zone and contacting it with wash water to displace excess value bearing material;
(iv) contacting the loaded resin with a stripping agent in a stripping zone, typically an acid or alkali, to strip the values from the resin and form one or more eluates;
(v) recovering the eluate(s), which may optionally be treated further to recover the values;
(vi) contacting the stripped resin with wash water in a second washing zone to displace excess stripping agent; and
(vii) returning the washed resin to the contact zone.

According to a further aspect of the invention, an apparatus for stripping or recovering values from a value bearing material comprises:
a body having one or more resin inlets and one or more resin outlets and comprising a plurality of successive, interconnected compartments between the resin inlet(s) and the resin outlet(s) through which resin introduced through the resin inlet(s) is arranged to pass to the resin outlet(s);
one or more of the compartments adjacent the resin inlet(s) defining a contact zone and including one or more value bearing material inlets for introducing value bearing material into the contact zone for loading values onto resin passing through the contact zone;
one or more of the compartments intermediate the contact zone and the resin outlet(s) defining a stripping zone and including one or more stripping agent inlets for introducing stripping agent into the stripping zone for stripping values from the loaded resin passing through the stripping zone;
one or more of the compartments adjacent the resin outlet(s) defining a resin washing zone and including one or more wash water inlets for introducing wash water into the washing zone to wash the stripped resin passing through the washing zone before exiting via the resin outlet(s); and
resin return means connecting the resin outlet(s) to the resin inlet(s) for returning washed resin from the washing zone to the contact zone in a continuous manner.

Preferably, one or more of the compartments intermediate the contact zone and the stripping zone define an additional washing zone and include one or more wash water inlets for introducing wash water into the additional washing zone for washing excess value bearing material from the loaded resin passing through the additional washing zone.

In one embodiment of the apparatus of the invention, the apparatus for stripping or recovering values from a value bearing material comprises:
a vessel body having a first end and a second end and defining a chamber between the first end and the second end;
a plurality of successive compartments located within the chamber between the first and second ends;
one or more value bearing material inlets located intermediate the first and second ends of the vessel body for introducing a value bearing material, such as a solution or slurry thereof, into the chamber, which value bearing material is arranged to flow through the successive compartments towards the first end;
one or more resin inlets located at or adjacent the first end of the vessel body for introducing a resin into the chamber, which resin is fluidised by the moving value bearing material in the various compartments and caused to flow from one compartment to another successive compartment towards the second end of the vessel body;
one or more resin outlet(s) adjacent the second end of the resin body for resin to exit from the chamber; and
resin return means connecting the resin outlet(s) to the resin inlet(s) for returning resin exiting from the resin outlet(s) to be re-introduced into the chamber,
   the arrangement being such that as resin and value bearing material contact each other in a counter current manner values from the value bearing material are absorbed onto the resin, which values can be recovered from the loaded resin.

In one version of this embodiment of the invention, the vessel body comprises a vertical column, the first end being located at the top of the column and the second end at the bottom of the column, the chamber being divided into the successive compartments by a plurality of spaced apart horizontal weirs. In this version of the invention, the value bearing material is arranged to flow in an upwards direction through the successive compartments to the top of the column, which fluidises resin flowing down through the column.

The weirs are typically in the form of trays, typically solid trays, located within the chamber at intervals between the upper and lower ends of the column body.

In an alternative version of this embodiment of the invention, the vessel body is an elongate horizontal tank or vessel that is divided into a number of successive compartments by a plurality of spaced apart vertical weirs. In this version of the invention, the value bearing material is arranged to flow upwards in successive compartments to fluidise resin passing from one compartment to the next over successive weirs.

In an alternative embodiment of the apparatus of the invention, the apparatus for stripping or recovering values from a value bearing material comprises:
a plurality of sealed tanks or containers arranged in series;
one or more value bearing material inlets into tanks or containers intermediate a first tank and a last tank in the series for introducing a value bearing material, such as a solution or slurry thereof, into the intermediate tank(s), which value bearing material is arranged to flow from the intermediate tanks through the series of tanks to the first tank in the series;
one or more resin inlets into the first tank in the series for introducing a resin into the first tank, which resin is fluidised by the moving value bearing material and caused to flow from the first tank through the series of tanks to the last tank;
one or more resin outlets in the last tank for resin to exit from the last tank; and
resin return means connecting the resin outlet(s) to the resin inlet(s) for returning resin exiting from the resin outlet(s) to be re-introduced into the first tank,
   the arrangement being such that as resin and value bearing material contact each other in a counter current manner values from the value bearing material are absorbed onto the resin, which values can be recovered from the loaded resin.

Importantly, but for the various inlets and outlets for allowing the flow of resin and value bearing material through the series of compartments, tanks or containers, the compartments, tanks or containers are otherwise sealed.

The apparatus typically includes a plurality of flow pipes linking the upper and lower ends of respective compartments, containers or tanks, thereby to provide pressure assisted flow of the value bearing material from one compartment, container or tank to the next.

The apparatus preferably includes one or more first wash water inlets that are arranged to introduce wash water into a first washing zone in the apparatus such that the bulk thereof is arranged to flow with the value bearing material to assist the flow of value bearing material through the apparatus and to wash off excess value bearing material from the resin flowing through the apparatus.

The apparatus preferably also includes one or more stripping agent inlets for introducing stripping agent into a stripping zone in the apparatus to strip or elute the values from the resin flowing through the stripping zone. In a preferred embodiment, a portion of the wash water from the first washing zone is arranged to flow through the stripping zone so as to prevent stripping agent in the stripping zone from mixing with value bearing material or resin in the first washing zone or contact zone. Importantly, therefore, the wash water provides a so-called water barrier that prevents mixing of value bearing material and stripping agent.

The apparatus preferably includes one or more second inlets for introducing wash water into a second washing zone in the apparatus for washing the stripped resin.

### BRIEF DESCRIPTION OF THE DRAWINGS

The invention will now be described in more detail, by way of example only, with reference to the accompanying drawings, in which:

FIG. 1 is a schematic cross-sectional side view of a first embodiment of the apparatus of the invention;

FIG. 2 is a schematic cross-sectional side view of a second embodiment of the apparatus of the invention; and

FIG. 3 is a schematic cross-sectional side view of a third embodiment of the apparatus of the invention.

### DETAILED DESCRIPTION OF A PREFERRED EMBODIMENT

The invention provides a process and apparatus for stripping or recovering values from a value bearing material that maintains a constant resin inventory in each stage while moving resin and value bearing material in a truly continuous counter-current fashion. This is done by establishing specified weir or resin take-off heights and managing and controlling inter-stage or inter-zone pressure differentials.

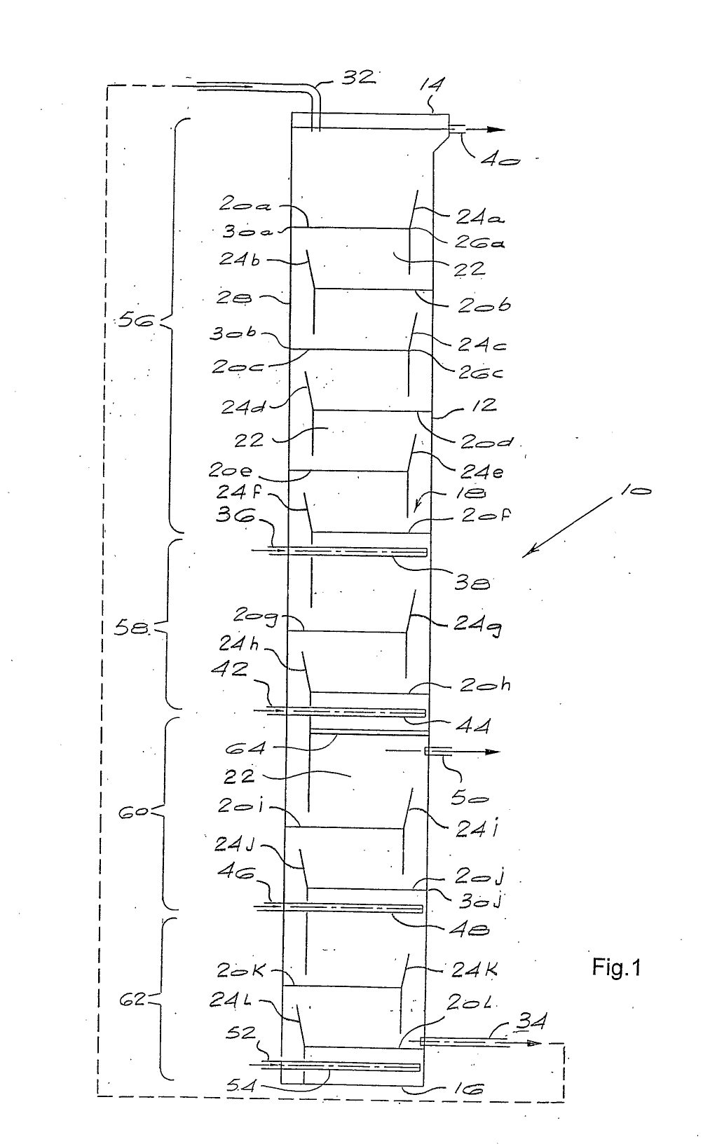

Referring to FIG. 1 of the accompanying drawings, there is shown a first embodiment of apparatus of the invention in the form of a column or tower 10.

The tower 10 consists of a column body 12, in this case an elongate column body, having an upper end 14, a lower end 16 and a chamber 18 defined therein. A plurality of trays 20 (a to l) are located at intervals between the upper end 14 and the lower end 16 of the column 10, respectively, thereby defining a number of compartments 22. As can be seen, the trays 20 are orientated such that successive trays are oppositely orientated to their immediate neighbours.

Each tray 20 has an overflow weir 24 at a free end 26 thereof, for allowing fluidised resin to pass thereover and flow to the next compartment 22 in the column. Each tray 20 is fixed to the side wall 28 of the column body 12 at a fixed end 30 of each tray 20.

Resin is introduced into the column 10 via the resin inlet 32 adjacent the upper end 14. The resin is arranged to pass down through the column and exit via the resin outlet 34 adjacent the lower end 16. Value bearing material, which shall be described as a slurry for convenience, is introduced into the chamber 18 via the slurry inlet 36 and feed tray 38 and caused to flow up through the column towards the upper end 14 and exit via the outlet or overflow 40. Wash water for the slurry is introduced into the chamber 18 via an inlet 42 and feed tray 44. The bulk of the water is arranged to flow up through the column and exit with the slurry through outlet 40. Acid or other appropriate stripping agent is introduced into the column 18 via an inlet 46 and feed tray 48 in order to strip value from the resin flowing down through the column. The value eluate obtained then exits via an outlet 50. Wash water for stripping the acid or other stripping agent from the depleted resin is introduced via inlet 52 and feed tray 54.

The tower 10 is typically divided into four zones by the various inlets. A contact zone 56 is defined between the resin inlet 32 and the slurry inlet 36. A slurry or first washing zone 58 is defined between the slurry inlet 36 and the wash water inlet 42. A stripping zone 60, which is typically an acid elution zone, is defined between the wash inlet 42 and the inlet 46. Finally, a second washing zone 62 is defined between the inlet 46 and the wash inlet 52.

Although the tower 10 as described has 12 trays 20, 6 in the contact zone 56 and 2 each in the first washing zone 58, the stripping zone 60 and the second washing zone 62, the total number of trays 20 and dimensions of the column body 12 can be adapted or changed for optimum processing.

The process of stripping value from a value bearing material will now be described with reference to FIG. 1. For convenience, the process will be described with reference to stripping metal values from a metal value bearing material. However, it is to be understood that the process of the invention encompasses the stripping of any values that can be captured on a resin. The process will also be described with reference to the resin movement and the aqueous phase movement (in the form of a slurry) separately, for convenience.

Depleted or fresh resin from outlet 34 is fed to the top tray 20a of the tower via inlet 32 (possibly by air lift). It is contacted with low tenor metal bearing slurry prior to the latter being discarded via outlet or overflow 40. The resin is fluidised by the upward movement of the slurry which has risen from inlet 36. A similar flowrate of resin is displaced from the fluidised resin mass and passes to the tray 20b below via the overflow weir 24a and the associated downcomer (not shown). Here the resin is contacted further with metal bearing slurry, this time of a higher metal tenor. Again the resin is fluidised by the upward movement of the slurry which has risen from the tray 20c below, and passes to the tray 20c via the overflow weir 24b. This continues until the resin is contacted with fresh slurry on the slurry feed plate 38.

The loaded resin falls through a series of water wash trays, in this case 20g and 20h in the washing zone 58, where excess slurry is displaced. As mentioned above, the wash water entering the chamber 18 via inlet 42 creates a water barrier by allowing a small portion thereof to flow down into the stripping zone 60 to prevent mixing of acid and slurry in zone 58. The plate 64 assists in preventing mixing of eluate and wash liquor.

The washed resin falls through the water barrier at the feed plate 44 to the stripping zone 60 where it is contacted, in this case, with acid for the recovery of a high metal tenor, essentially solids free solution. The water is cascade controlled by increasing the discharge of eluate until a suitable pH is maintained at a pre-determined point above the eluate discharge 50. The resin then passes over several elution trays, in this case 20i and 20j in zone 60.

The stripped resin passes through the water wash zone 62 where excess acid is displaced.

Depleted washed resin is drawn from the outlet 34 and flows, by an air lift, to the top of the column 14 as feed.

Slurry is fed into the chamber 18 through inlet 36 and the slurry feed tray 38 and passes upwards through the compartments 22 of successive trays 20f to 20a. It passes through the resin beds at a rate sufficient to suitably fluidise the resin. The pH of the slurry is maintained to drive the metals absorption reaction (this can be achieved by lime addition at various points along the slurry flow path). The slurry discharges via the outlet or column overflow 40 to disposal. Typically, the successive compartments are linked by pipes (not shown), which have associated pumps to increase pressure to assist the upwards flow of the slurry.

Several trays 20 below the slurry feed inlet 36, wash water for the slurry on the resin is introduced via inlet 42. The bulk of this wash water flows upwards via the compartments 22 and associated pipes (not shown) and through the associated resin beds in the wash zone 58. The cross sectional area of the trays 20 is designed to ensure resin fluidisation at this reduced flowrate. A portion of this wash water passes in a downwards direction and is sacrificed to the metal eluate (which slightly decreases the tenor of this solution). This forms the water barrier as described above. This downwards flow is controlled by the release of eluant via the discharge control valve 50, which is set at a pH value sufficient to maintain the integrity of the water barrier. The upwards portion of the wash water combines with the feed slurry and is eventually discharged via outlet or overflow 40.

Several trays 20 below the wash water for slurry on resin feed point 42, eluant (either spent electrolyte or dilute acid) is introduced via inlet 46. This flows upwards through the compartments 22 and associated pipes (not shown) and through the associated resin beds in the zone 60. The cross sectional areas of the trays are designed to ensure resin fluidisation at this reduced flowrate. If necessary, additional means may be provided to ensure resin fluidization, for example a recycle loop, which can also be used for resin movement. The eluant strips the metal off the resin in a stepwise manner (as described in the loading stages). This combines with the downflow of water from the wash water for slurry on resin stage as described above. The metal value can then be recovered from the eluate in a conventional manner such as electrowinning or precipitation. Typically the eluate will be combined with an existing processing stream for metals recovery.

Although the tower 10 as described has a plate type weir and downcomer arrangement, resin transfer can also be effected by means of a pipe. The pipe may be situated either inside or outside of the tower.

In the illustrated arrangement, tower 10 utilises gravity and/or hydraulic assistance to cause resin to flow from one compartment to another in a controlled manner.

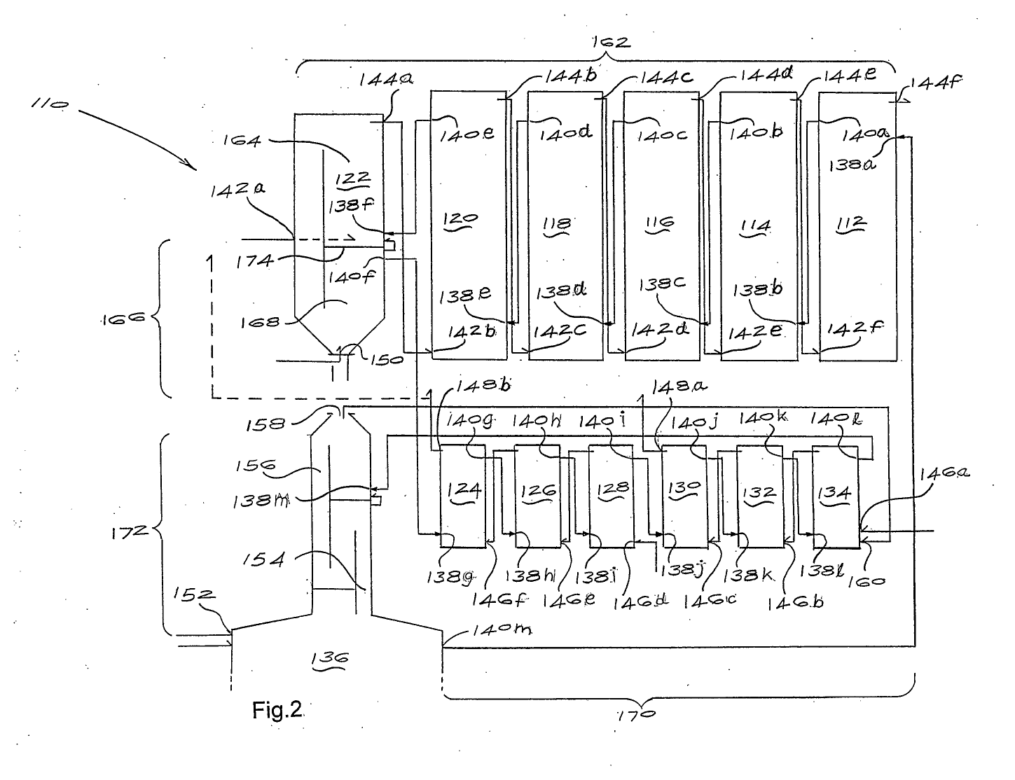

Referring to FIG. 2 of the accompanying drawings, there is shown a second embodiment of an apparatus 110 of the invention.

The apparatus 110 consists of a plurality of sealed tanks or vessels (112 to 136), which define the various zones for carrying out the process of the invention. Each of the tanks or containers 112 to 122 has a resin inlet 138 (a to f), a resin outlet 140 (a to f), a slurry inlet 142 (f to a) and a slurry outlet 144 (f to a). Each of the tanks or containers 124 to 136 has a resin inlet 138 (g to m), a resin outlet 140 (g to m), and a stripping agent inlet 146 (a to f). Tanks 130 and 124, in this arrangement, have eluate outlets 148a and 148b, respectively.

Resin is introduced via the resin inlet 138a into the first tank 112, which once loaded with metal values exits via outlet 140a. The resin is then arranged to pass through the successive tanks 114 to 136, via the respective resin inlets 138 and outlets 140, and to eventually exit via the resin outlet 140m. Value bearing material, which shall be described as a slurry for convenience, is introduced into the tank 122 via the slurry inlet 142a and exits via slurry outlet 144a. It is then pumped in a counter-current manner through successive tanks 120 to 112 via respective slurry inlets 142 and outlets 144, and eventually to exit via the outlet or overflow 144f.

Wash water for the slurry is introduced into the tank 122 via an inlet 150. The bulk of the water is arranged to flow through successive tanks 122 to 112 and exit with the slurry through outlet 144f.

Acid or other appropriate stripping agent is introduced, in this arrangement, into tank 134 via inlet 146a in order to strip value from the resin flowing through tank 134. This is continued in tanks 132, 130 and the first value eluate obtained then exits via outlet 148a. Likewise, stripping agent introduced into tank 128 via inlet 146d strips the metal values in respective tanks 128, 126,124 before the second value eluate exits via outlet 148b.

Water for washing the excess acid or other stripping agent from the depleted resin is introduced via inlet 152 and flows via chamber 154 into chamber 156 were washing takes place. The wash water then passes via outlet 158 for re-introduction into tank 134 via inlet 160.

The apparatus is divided into four zones by the various tanks. A contact zone 162 is defined by the tanks 112 to 120 and a portion 164 of tank 122. A slurry or first washing zone 166 is defined by a portion 168 of tank 124. A stripping zone 170, which is typically an acid elution zone, is defined by tanks 124 to 134. Finally, a second washing zone 172 is defined by tank 136.

Once again, the number and arrangement of tanks may be adapted or changed for optimum processing.

The process of stripping value from a value bearing material will now be described with reference to FIG. 2 of the accompanying drawings. Once again, for convenience, the process will be described with reference to stripping metal values from a metal value bearing material.

Depleted or fresh resin from outlet 140m is fed to the top of tank 112 via inlet 138a, typically by airlift. It is contacted with low tenor metal bearing slurry prior to the latter being discarded via outlet or overflow 144f. The resin is fluidised by the upward movement of the slurry which has risen from inlet 142f. A similar flowrate of resin is displaced from the fluidised resin mass and passes to the tank 114 via the outlet 140a and inlet 138b. Here the resin is contacted further with metal bearing slurry, this time of a higher metal tenor. Again the resin is fluidised by the upward movement of the slurry which has risen from the inlet 142e, and passes to the tank 116 via the outlet 140b and inlet 138c. This continues until the resin is contacted with fresh slurry from inlet 142a and its associated feed plate 174.

The loaded resin passes through the water tank 122 in the washing zone 166, where excess slurry is displaced. As mentioned above, the wash water entering the tank 122 via inlet 150 creates a water barrier by allowing a small portion thereof to flow into the tank 124 to prevent mixing of acid and slurry in zone 166.

The washed resin passes from outlet 140f, together with some wash water, into tank 124 via inlet 138g where it is contacted, in this case, with acid for the recovery of a high metal tenor, essentially solids free solution. The water is cascade controlled by increasing the discharge of eluate until a suitable pH is maintained at a pre-determined point above the respective eluate discharge outlets 148a and 148b. The resin then passes through several elution tanks 124 to 134 in zone 170, for further stripping of the resin.

The stripped resin passes from outlet 140t through the water wash zone 172 via inlet 138m where excess acid is displaced.

Depleted washed resin is drawn from the outlet 140m and is transferred by an air lift to the top of the tank 112.

Slurry is fed into tank 122 through inlet 142a and the slurry feed tray 174 and passes upwards through successive tanks 122 to 112 via respective inlets 142 and outlets 144. It passes through the resin beds at a rate sufficient to suitably fluidise the resin. The pH of the slurry is maintained to drive the metals absorption reaction (this can be achieved by lime addition at various points along the slurry flow path). The slurry discharges via the outlet overflow 144f to disposal. Typically, the successive tanks are linked by pipes and associated pumps, which increase pressure to assist the upwards flow of the slurry.

Wash water for the slurry on the resin is introduced via inlet 150. The bulk of this wash water flows upwards through tank 122 and through the associated resin bed in the wash zone 166. The cross sectional area of the tank is designed to ensure resin fluidisation at this reduced flowrate. A portion of this wash water is sacrificed to the metal eluate (which slightly decreases the tenor of this solution). This forms the water barrier as described above. This flow is controlled by the release of eluant via the discharge control valves 148a and 148b, which are set at a pH value sufficient to maintain the integrity of the water barrier. The upwards portion of the wash water combines with the feed slurry and is eventually discharged via outlet or overflow 144f.

Eluant is introduced via inlets 146d and 146a. This flows through successive tanks 128 to 124 and 134 to 130, respectively, and through the associated resin beds in the zone 170. The cross sectional areas of the tanks or recycle loops (not shown) are designed to ensure resin fluidisation at this reduced flowrate. The eluant strips the metal off the resin in a stepwise manner (as described in the loading stages). This combines with the flow of water from the wash water for slurry on resin stage as described above. The metal value can then be recovered from the eluate in a conventional manner such as electrowinning or precipitation. Typically the eluate will be combined with an existing processing stream for metals recovery.

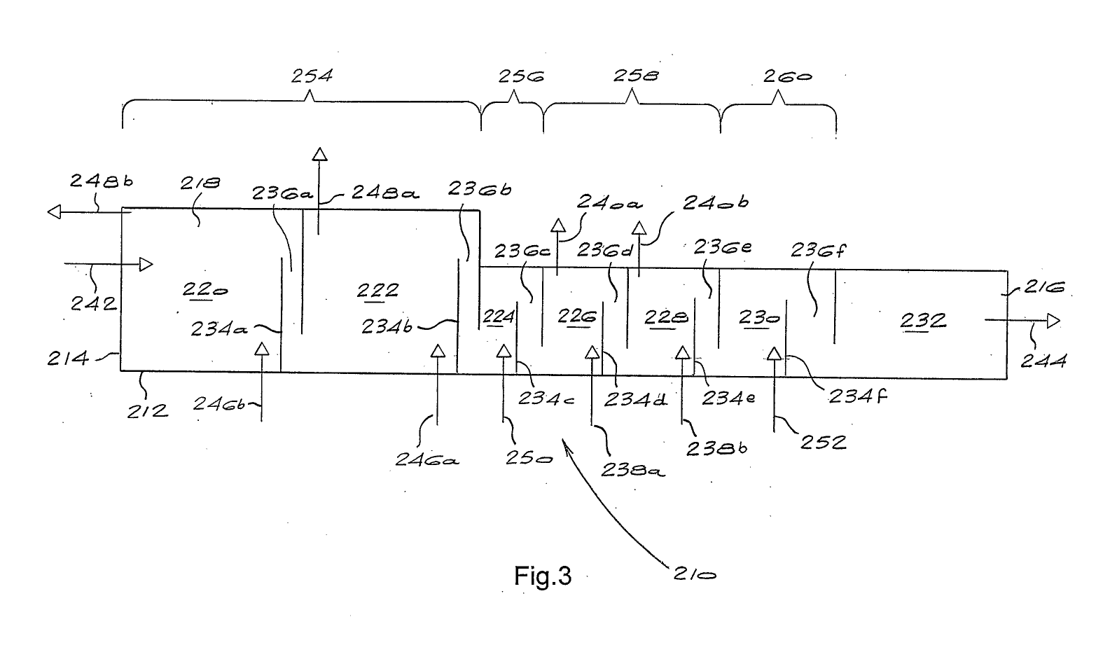

Referring to FIG. 3 of the accompanying drawings, there is shown a third embodiment of an apparatus 210 of the invention.

The apparatus 210 consists of an apparatus body 212 having a first end 214 and a second end 216 and defining a sealed chamber 218 therebetween. The chamber 218 in turn comprises a plurality of compartments or vessels (220 to 232), which define the various zones for carrying out the process of the invention. Each compartment (220 to 230) has an overflow weir 234 (a to f), for allowing fluidised resin to pass thereover and flow to the next compartment (222 to 232) via the respective downcomers 236 (a to f) in the apparatus. Compartments 226 and 228, in this arrangement, have stripping agent inlets 238a and 238b, and eluate outlets 240a and 240b, respectively.

Resin is introduced via a resin inlet 242, adjacent the first end 214, into the first compartment 220, which once loaded with metal values passes to compartment 222 via downcomer 236a. The resin is then arranged to pass through the successive compartments 222 to 232, via the respective resin downcomers 236 (b to f), and to eventually exit via the resin outlet or overflow 244, adjacent second end 216. Value bearing material, which shall be described as a slurry for convenience, is introduced into the compartment 222 via the slurry inlet 246a and exits via slurry outlet 248a. It is then introduced into compartment 220 via inlet 246b and then exits via the outlet 248b.

Wash water for the slurry is introduced into the compartment 224 via an inlet 250. The bulk of the water is arranged to flow through compartments 222 and 220 and to exit with the slurry through outlet 248b.

Acid or other appropriate stripping agent is introduced, in this arrangement, into compartment 228 via inlet 238b in order to strip value from the resin flowing through compartment 228. The first value eluate obtained then exits via outlet 240b. Likewise, stripping agent introduced into compartment 226 via inlet 238a strips the metal values in compartment 226 before the second value eluate exits via outlet 240a. Water for washing the acid or other stripping agent from the depleted resin is introduced via inlet 252 into chamber 230 where washing takes place. The bulk of the water is arranged to flow through compartment 228 and exit with the first value eluate through outlet 240b.

The apparatus is divided into four zones by the various compartments. A contact zone 254 is defined by the compartments 220 to 222. A slurry or first washing zone 256 is defined by compartment 224. A stripping zone 258, which is typically an acid elution zone, is defined by compartments 226 to 228. Finally, a second washing zone 260 is defined by compartment 230.

Once again, the number and arrangement of compartments may be adapted or changed for optimum processing.

The process of stripping value from a value bearing material will now be described with reference to FIG. 3 of the accompanying drawings. Once again, for convenience, the process will be described with reference to stripping metal values from a metal value bearing material.

Depleted or fresh resin from outlet or overflow 244 is fed at a controlled rate to the top of compartment 220 via inlet 242, typically by air lift. It is contacted with low tenor metal bearing slurry prior to the latter being discarded via outlet 248b. The resin is fluidised by the upward movement of the slurry which has risen from inlet 246b. A similar flowrate of resin is displaced from the fluidised resin mass and passes to the compartment 222 via the downcomer 236a. Here the resin is contacted further with metal bearing slurry, this time of a higher metal tenor, prior to exiting via outlet 248a and being introduced into compartment 220 via inlet 246b. The resin is fluidised by the upward movement of the fresh slurry, which has risen from the inlet 246a.

The loaded resin then passes from compartment 222 to compartment 224 via downcomer 236b. In compartment 224, which defines the washing zone 256, excess slurry is displaced. As mentioned above, the wash water entering the compartment 224 via inlet 250 creates a water barrier by allowing a small portion thereof to flow into the compartment 226 to prevent mixing of acid and slurry in zone 256.

The washed resin then passes via downcomer 236c, together with some wash water, into compartment 226 where it is contacted, in this case, with acid introduced via inlet 238a for the recovery of a high metal tenor, essentially solids free solution. The resin then passes from compartment 226 to 228 in zone 258, where a similar stripping step takes place. The discharge eluate exits from compartments 226 and 228 via respective outlets 240a and 240b.

The stripped resin then passes via downcomer 236e to compartment 330 which defines the second water wash zone 260, where excess acid is displaced.

Depleted washed resin is drawn from the outlet 244 and flows by an air lift to the top of the compartment 220 as feed.

Slurry is fed into compartment 222 through inlet 246a and passes upwards through compartments 222 and 220 via respective inlets 246 and outlets 248. It passes through the resin beds at a rate sufficient to suitably fluidise the resin. The pH of the slurry is maintained to drive the metals absorption reaction (this can be achieved by lime addition at various points along the slurry flow path). The slurry discharges via the outlet 248b to disposal. Typically, the successive compartments are linked by pipes, and associated pumps, which increase pressure to assist the upwards flow of the slurry.

Wash water for the slurry on the resin is introduced via inlet 250. The bulk of this wash water flows upwards through compartment 224 and through the associated resin bed in the wash zone 256. The cross sectional area of the compartment is designed to ensure resin fluidisation at this reduced flowrate. A portion of this wash water is sacrificed to the metal eluate (which slightly decreases the tenor of this solution). This forms the water barrier as described above. This flow is controlled by the release of eluant via the outlets 240a and 240b, which comprise discharge control valves, and which are set at a pH value sufficient to maintain the integrity of the water barrier. The upwards portion of the wash water combines with the feed slurry and is eventually discharged via outlet 248b.

Eluant is introduced via inlets 238b and 238a. This flows through compartments 228 and 226, respectively, and through the associated resin beds in the zone 258. The cross sectional areas of the compartments or recycle loops (not shown) are designed to ensure resin fluidisation at this reduced flowrate. The eluant strips the metal off the resin in a stepwise manner (as described in the loading stages). This combines with the flow of water from the wash water for slurry on resin stage as described above. The metal value can then be recovered from the eluate in a conventional manner such as electrowinning or precipitation. Typically the eluate will be combined with an existing processing stream for metals recovery.

The apparatus and process of the invention provide a number of advantages over existing systems and processes, including that the apparatus has no moving parts.

Further, the apparatus can economically recover entrained losses of soluble “values” from various waste streams arising from various operations. Typically barren slurry tenors in the order of parts per million can be achieved. This represents not only significant additional recovery but also a more environmentally friendly residue.

The apparatus can also be used for processing of intermediate streams, such as primary leach liquor slurries or solutions, in recovering metal values such as from electroplating solutions, in the treatment of sewerage, and for the demineralisation or treatment of water, and from other process liquors or slurries. This technology also has advantages over solvent extraction processes.

Values can be selectively loaded and stripped from the resin to form a number of purified (or enriched) eluate products.

Control of the apparatus operation is simple and maintenance and capital costs are low.

As a result of the apparatus design, wash solutions can also be controlled. Consequently, the apparatus can be set either to produce a fixed flowrate of value material at varying concentrations or a fixed concentration of value material at a varying flowrate

The apparatus design also significantly reduces resin inventories compared to those associated with normal carousel semi-batch type designs because of the inherent “dead times” associated with resin transfer/washing etc. for such operations. The design also significantly reduces resin losses through abrasion associated with resin handling in such designs. Resin inventory is also significantly reduced by optimisation of contact times for each process “step” which is made possible by application of the relevant design principles.

Another advantageous feature of the apparatus is the “water barrier seal” which prevents mixing of slurry and stripping agent. In this feature some water from the resin slurry wash water is sacrificed to the strip liquor thereby forming a barrier which prevents stripping agent from prematurely coming into contact with the loaded resin. Loaded resin passes through this barrier unaffected from the loading stage into the stripping stage.

1. A continuous process for stripping or recovering values from a value bearing material including the steps of:
(i) providing a resin and a source of value bearing material;
(ii) contacting the resin and value bearing material in a countercurrent manner in a contact zone to load the resin with values from the value bearing material, the resin being fluidised by the value bearing material in the contact zone;
(iii) optionally passing the loaded resin through a first washing zone and contacting it with wash water to displace excess value bearing material;
(iv) contacting the loaded resin with a stripping agent in a stripping zone to strip the values from the resin and from one or more eluates;
(v) recovering the eluate(s), which may optionally be treated further to recover the values;
(vi) contacting the stripped resin with wash water in a second washing zone to displace excess stripping agent; and
(vii) returning the washed resin to the contact zone.

2. A process according to claim 1, wherein the source of value bearing material is a slurry or solution containing the value bearing material.

3. A process according to claim 1 or claim 2, wherein a substantially constant resin inventory is maintained in each of the zones.

4. A process according to claim 3, wherein a substantially constant resin inventory is maintained in each zone by controlling the slurry or solution flowrates between all zones.

5. A process according to any one of claims 1 to 4 claim 1, wherein the source of value bearing material is a waste stream, a primary leach liquor slurry or solution, a metal value slurry or solution, sewerage, water to be demineralised or treated or a process liquor or slurry.

6. A process according to claim 1, wherein the value bearing material comprises metal values.

7. A process according to claim 1, wherein the stripping agent is an acid or an alkali.

8. An apparatus for stripping or recovering values from a value bearing material comprising:
a body having one or more resin inlets and one or more resin outlets and comprising a plurality of successive, interconnected compartments between the resin inlet(s) and the resin outlet(s) through which resin introduced through the resin inlet(s) is arranged to pass to the resin outlet(s);
one or more of the compartments adjacent the resin inlet(s) defining a contact zone and including one or more value bearing material inlets for introducing value bearing material into the contact zone for loading values onto resin passing through the contact zone;
one or more of the compartments intermediate the contact zone and the resin outlet(s) defining a stripping zone and including one or more stripping agent inlets for introducing stripping agent into the stripping zone for stripping values from the loaded resin passing through the stripping zone;
one or more of the compartments adjacent the resin outlet(s) defining a resin washing zone and including one or more wash water inlets for introducing wash water into the washing zone to wash the stripped resin passing through the washing zone before exiting via the resin outlet(s); and
resin return means connected the resin outlet(s) to the resin inlet(s) for returning washed resin from the washing zone to the contact zone in a continuous manner.

9. An apparatus according to claim 8, wherein one or more of the compartments intermediate the contact zone and the stripping zone define an additional washing zone and include one or more wash water inlets for introducing wash water into the additional washing zone for washing excess value bearing material from the loaded resin passing through the additional washing zone.

10. An apparatus according to claim 9, wherein the additional washing zone is arranged such that the majority of wash water introduced therein flows with the value bearing material through the contact zone whilst a small portion of the introduced wash water flows with the resin through the stripping zone, thereby forming a water barrier between the contact zone and the stripping zone.

11. An apparatus for stripping or recovering values from a value bearing material comprising:
a vessel body having a first end and a second end and defining a chamber between the first end and the second end;
a plurality of successive compartments located within the chamber between the first and second ends;
one or more value bearing material inlets located intermediate the first and second ends of the vessel body for introducing a value bearing material into the chamber, which value bearing material is arranged to flow through the successive compartments towards the first end;
one or more resin inlets located at or adjacent the first end of the vessel body for introducing a resin into the chamber, which resin is fluidised by the moving value bearing material in the various compartments and caused to flow from one compartment to another successive compartment towards the second end of the vessel body;
one or more resin outlet(s) adjacent the second end of the resin body for resin to exit from the chamber; and
resin return means connecting the resin outlet(s) to the resin inlet(s) for returning resin exiting from the resin outlet(s) to be re-introduced into the chamber,
the arrangement being such that as resin and value bearing material contact each other in a counter current manner values from the value bearing material are absorbed onto the resin, which values can be recovered from the loaded resin.

12. An apparatus according to claim 11, wherein the vessel body comprises a vertical column, the first end being located at the top of the column and the second end at the bottom of the column, the chamber being divided into the successive compartments by a plurality of spaced apart horizontal weirs.

13. An apparatus according to claim 12, wherein the value bearing material is arranged to flow in an upwards direction through the successive compartments to the top of the column, which fluidises resin flowing down through the column.

14. An apparatus according to claim 12, wherein the weirs are in the form of trays located within the chamber at intervals between the upper and lower ends of the column body.

15. An apparatus according to claim 11, wherein the vessel body is an elongate horizontal tank or vessel that is divided into a number of successive compartments by a plurality of spaced apart vertical weirs.

16. An apparatus according to claim 15, wherein the value bearing material is arranged to flow upwards in successive compartments to fluidise resin passing from one compartment to the next over successive weirs.

17. An apparatus according to claim 12, wherein the weirs have respective downcomers for assisting the flow of resin and/or value bearing material from one compartment to another.

18. An apparatus for stripping or recovering values from a value bearing material comprising:
a plurality of sealed tanks or containers arranged in series;
one or more value bearing material inlets into tanks or containers intermediate a first tank and a last tank in the series for introducing a value bearing material into the intermediate tank(s), which value bearing material is arranged to flow from the intermediate tanks through the series of tanks to the first tank in the series;
one or more resin inlets into the first tank in the series for introducing a resin into the first tank, which resin is fluidised by the moving value bearing material and caused to flow from the first tank through the series of tanks to the last tank;
one or more resin outlets in the last tank for resin to exit from the last tank; and
resin return means connecting the resin outlet(s) to the resin inlet(s) for returning resin exiting from the resin outlet(s) to be re-introduced into the first tank,
the arrangement being such that as resin and value bearing material contact each other in a counter current manner values from the value bearing material are absorbed onto the resin, which values can be recovered from the loaded resin.

19. An apparatus according to claim 18, which includes a plurality of flow pipes linking the upper and lower ends of respective containers or tanks, thereby to provide pressure assisted flow of the value bearing material from one container or tank to the next.

20. An apparatus according to claim 11, which includes one or more first wash water inlets that are arranged to introduce wash water into a first washing zone in the apparatus such that the bulk thereof is arranged to flow with the value bearing material to assist the flow of value bearing material through the apparatus and to wash off excess value bearing material from the resin flowing through the apparatus.

21. An apparatus according to claim 11, which includes one or more stripping agent inlets for introducing stripping agent into a stripping zone in the apparatus to strip or elute the values from the resin flowing through the stripping zone.

22. An apparatus according to claim 21, wherein a portion of the wash water from the first washing zone is arranged to flow through the stripping zone so as to prevent stripping agent in the stripping zone from mixing with value bearing material or resin in the first washing zone or contact zone.

23. An apparatus according to claim 21 or claim 22, which includes one or more second inlets for introducing wash water into a second washing zone in the apparatus for washing the stripped resin.

24. (canceled)

25. (canceled)
